(19) United States
(12) Patent Application Publication
(10) Pub. No.: US 2015/0100877 A1
(43) Pub. Date: Apr. 9, 2015

(54) METHOD OR SYSTEM FOR AUTOMATED EXTRACTION OF HYPER-LOCAL EVENTS FROM ONE OR MORE WEB PAGES

(71) Applicant: Yahoo! Inc., Sunnyvale, CA (US)

(72) Inventors: Chong Long, Beijing (CN); Xin Li, Sunnyvale, CA (US); Zhaohul Zheng, Mountain View, CA (US); Sathiya Keerthi Selvaraj, Cupertino, CA (US); Xiubo Geng, Beijing, CA (US)

(21) Appl. No.: 13/695,774

(22) PCT Filed: Jun. 29, 2012
(86) PCT No.: PCT/CN2012/000904

§ 371 Date: Nov. 1, 2012

(51) Int. Cl. G06F 17/22; G06F 9/54

(52) U.S. Cl. CPC G06F 17/2247; G06F 9/542
USPC 715/234

(57) ABSTRACT

Methods and systems are provided that may be utilized to extract hyper-local event information from one or more web pages.

### CROSS-REFERENCE TO RELATED APPLICATION

This application claims priority to International Application No. PCT/CN2012/000904 entitled “Method or System for Automated Extraction of Hyper-Local Events from One or More Web Pages” which was filed on Jun. 29, 2012, and which is assigned to the assignee of the currently claimed subject matter, the subject matter of which is incorporated by reference herein.

### BACKGROUND

1. Field

The subject matter disclosed herein relates to a method or system for automated extraction of hyper-local events from one or more web pages.

2. Information

Web pages for various organizations or entities may display or otherwise present descriptors of or descriptions relating to various events, such as a date for an event, a summary of the event, a time of the event, or duration of the event, to name just a few examples. Such information relating to one or more events may be presented to a user of a web page portal, search engine, or some other type of web page capable of aggregating such information.

Descriptions relating to events may be presented in one or more varied formats. Given the number of web pages available via the Internet, accumulation and presentation of hyper-local event descriptions may be a useful feature a web page portal or social networking website, for example.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is diagram of a 2-dimensional event calendar page according to an embodiment.

FIG. 2 is diagram of an event list page according to an embodiment.

FIG. 3 is diagram of an event details page according to an embodiment.

FIG. 4 is a diagram of an automatic event extraction system according to an embodiment.

FIG. 5 is a flowchart of a process for 2-dimensional calendar extraction according to an implementation.

FIG. 6 is a flow diagram of a process to rank two or more candidate web page wrappers according to an embodiment.

FIG. 7 is a schematic diagram illustrating a computing environment system that may include one or more devices to automatically extract hyper-local events from one or more web pages.

### DETAILED DESCRIPTION

Reference throughout this specification to “one example”, “one feature”, “an example”, or “a feature” means that a particular feature, structure, or characteristic described in connection with the feature or example is included in at least one feature or example of claimed subject matter. Thus, appearances of the phrase “in one example”, “an example”, “in one feature” or “a feature” in various places throughout this specification are not necessarily all referring to the same feature or example. Furthermore, particular features, structures, or characteristics may be combined in one or more examples or features.

With the accelerated growth of Internet and mobile technology, hyper-local service is becoming more and more popular for various types of Internet products, such as social networking web sites, portals, or applications, for example. “Hyper-local,” as used herein may refer to a service, description, or offer, for example, that is oriented around a well-defined community. For example, a hyper-local service may be focused upon concerns or interests of residents of a particular community. In one particular example embodiment, a hyper-local service may present or otherwise provide descriptors or descriptions of or relating to scheduled baseball games or road closures within a particular city.

Upcoming event descriptors or descriptions may comprise an aspect of a hyper-local service. An “upcoming event,” as used herein, may refer to an event which is organized by people or a community and is scheduled to occur at some point within the future, such as within the near future. An upcoming event may be publicly announced on one or more web pages to indicate a name or subject matter of the event, a starting time or duration, or a location of the event, for example. Olympic games, international conferences, birthday parties, movie shows, baseball games, or speeches are just a few among many possible examples of events.

Website operators may provide users with hyper-local event service in different ways. In one particular implementation, users may manually create events and share descriptions of the events with friends. Some hyper-local services may be available via a mobile technology, such as via an application program available to a mobile device. For example, a calendar application or tool may allow a user to record and publish event agendas. In some embodiments, websites may display aggregations of events. A potential drawback of some implementations, however, is that a requirement that one or more users manually edit or input a description of an event. Moreover, event coverage may be limited if only manually edited or input descriptions of events are available.

Many individuals may present descriptions of events organized by people primarily, or possibly exclusively, on independent websites of a particular community, such as, for example, events that occur within schools, libraries, or city governments, to name just a few among many possible examples. A number of such websites may be relatively numerous. If such descriptions of upcoming events are capable of being extracted from such websites, the descriptions may be valuable if presented to a user.

An event description extraction method that requires site level supervision, however, may be cost or resource-prohibitive. To be scalable, for example, an automatic event extraction system that may aggregate descriptions of events from general sites across the whole Internet may be capable of improving coverage of hyper-local events.

As discussed herein, in an embodiment, descriptions relating to upcoming hyper-local events may be extracted from one or more websites or other sources in an automated way. For example, hyper-local event descriptions may be provided to a person planning a vacation, by presenting descriptions relating to upcoming events that are scheduled to occur at a vacation destination, such as at the 2012 Music Festival in Venice or at the San Francisco Zoo, to name just a couple among many possible examples. In one particular embodiment, an event directory may be displayed to a user of a web service, for example, to visually display descriptions relating to one or more upcoming events.

In an embodiment as discussed herein, events may be detected across a relatively large number of web sites such as, for example, hundreds of thousands of web sites. According to an embodiment, descriptions relating to events may be extracted from heterogeneous formats utilized on web sites. Descriptions relating to one or more events may be extracted from an event page. An “event page,” as used herein may refer to a web page of a website on which descriptions relating to one or more events is presented. An event page may present descriptions as a calendar, event list, or an event detail page, for example. Relatively sophisticated linguistic patterns may be processed while extracting different attributes from an event page. An event may comprise or be associated with one or more attributes, such as, for example, a title, date, time, location, or other descriptions, for name just a few examples of attributes. Different attributes may be utilized on different event pages. An event's date or time may be relatively short and well-formed as presented on an event page, but an event detail description may be relatively long and unstructured, for example.

As discussed herein, an embodiment may utilize a hybrid framework extract event descriptions from event pages. In accordance with a hybrid framework of an embodiment, a binary event page classifier may be generated to detect event pages (e.g., web pages with event attributes). Detected event pages may be separated or divided into three groups: (a) two-dimensional (2D) calendar pages; (b) event list pages; or (c) event detail pages. In a particular embodiment, two different strategies may be utilized for extraction: (a) a heuristic calendar parser may be utilized to extract event descriptions from 2D calendar pages; and (b) a semi-supervised approach (e.g., one that does not need per-site supervision) may be utilized for event list and event detail pages, as discussed further below.

Descriptions may be extracted from lists or tables included in Hypertext Markup Language (HTML) web pages. A “list” or a table, as used herein, may refer to a series of similar data items or data records. For example, a list may include similar data items or data records arranged either in one-dimensional or two-dimensional formats.

According to one particular implementation, HTML tags may be processed or analyzed to locate one or more lists or tables. A list or a table may have specific HTML tags such as <table>, <tr>, <td>, <UL>, <OL>, <DL>, or <H1>-<H6>, to name just a few possible example. Accordingly, if such HTML tags are located and analyzed within HTML code, contents of lists or tables may be determined.

According to one particular implementation, structure patterns or wrappers of a web page may be analyzed or processed. A “structure pattern” or “wrapper,” as used herein, may refer to a format of a web page indicative of one or more locations at which event descriptions may be listed or presented. For example, such a method may not make any assumptions about a type of HTML tags used to construct the data records. Instead, Document Object Model (DOM)-tree structures and string patterns may be used to generate wrappers. As compared to HTML tag-based methods, structure and wrapper based ones may be considered more general, but may also incur greater difficultly generating string patterns or wrappers, particularly if manual or human supervision is not available for each given structure.

According to one particular approach, visual signals may be analyzed or processed to extracted event descriptions. A “visual signal,” as used herein, may refer to a visually perceptible indication of a listing table. For example, in some implementations, a list or table may not be readily perceptible by analyzing HTML code, but may be identified by analyzing a rendering of a visual output. For example, event list extraction methods may utilize visual alignment of objects in a rendered web page to identify a list or table. A result of a web page rendering process may be regarded as a set of hierarchically arranged rectangular bounding boxes, for example. One or more rendered boxes in a resulting web page may have a position and size, and may contain content such as text or images, for example, or one or more additional boxes within them. Similar to wrappers, a lack of human or manual supervision per a visual format may make automatic extraction difficult via visual signals.

An event page may be unstructured, semi-structured, or structured, for example. In an unstructured event page in accordance with an embodiment, event descriptions may be published in a free-text way. It may, however, be difficult to accurately extract descriptions from free text, so a focus of an embodiment may be on extraction of event descriptions from structured and semi-structured pages. Also, a loss of coverage due to leaving out unstructured cases may not be high, as discussed further below. Structured and semi-structured event pages may be grouped into three types: 2-D calendar pages, event list pages, and event detail pages.

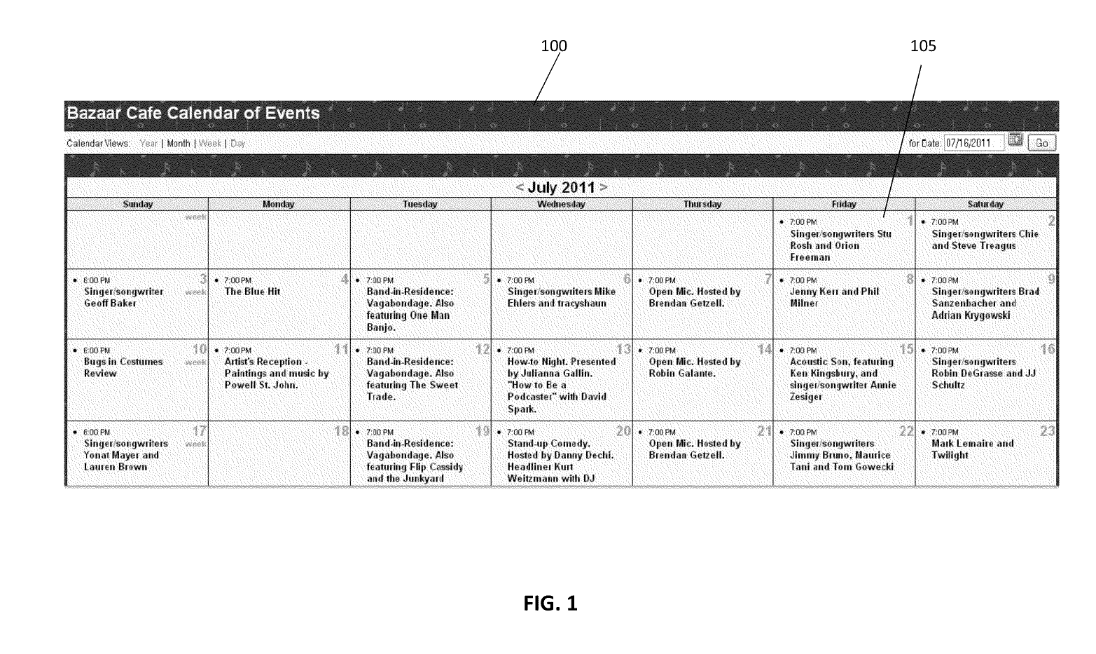

FIG. 1 is diagram of a 2-D event calendar page 100 according to an embodiment. As illustrated, 2-D event calendar page 100 includes one or more 2-D table structures. A full table may represent a whole month or a whole week in an implementation. A calendar cell 105 may represent one day, such as Friday, Jul. 1, 2011 in this example. Events associated with the same date may be located within the same call in 2-D event calendar page 100. Accordingly, if two different events are listed as scheduled for Jul. 1, 2011, both events may be listed within calendar cell 105. As shown, calendar cell 105 may indicate a date such as Jul. 1, 2011, an event description or name, such as “Singer/songwriters Stu Rosh and Orion Freeman,” and a time of day at which the event is scheduled to start, such as 7:00 P.M. in this example. It should, of course, be appreciated that additional or different types of descriptions relating to an event may be presented or displayed within calendar cell 105.

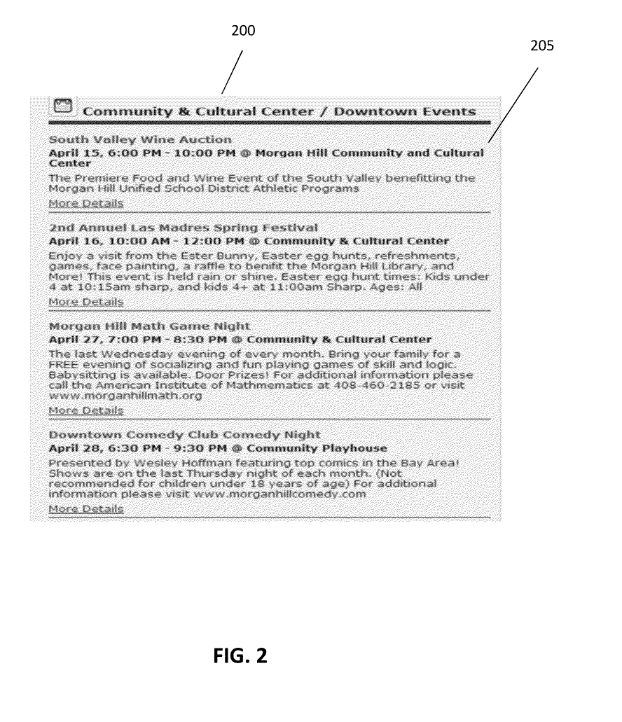

FIG. 2 is diagram of an event list page 200 according to an embodiment. Events list page 200 may be organized as a list-wise form. An event list page 200, such as the one shown in FIG. 2 may contain or present descriptions for multiple events. An entry on event list page 200 may indicate a name of an event, a time for the event, such as a starting time or duration, a synopsis of or a location for the event. As shown, a first event listing 205 is entitled “South Valley Wine Auction,” and is scheduled for April 15 between 6:00 P.M. and 10:00 P.M. to occur at Morgan Hill Community and Cultural Center. A description of an event as shown for first event listing 200 reads, “The Premier Food and Wine Event of the South Valley benefitting the Morgan Hill Unified School District Athletic Programs.”

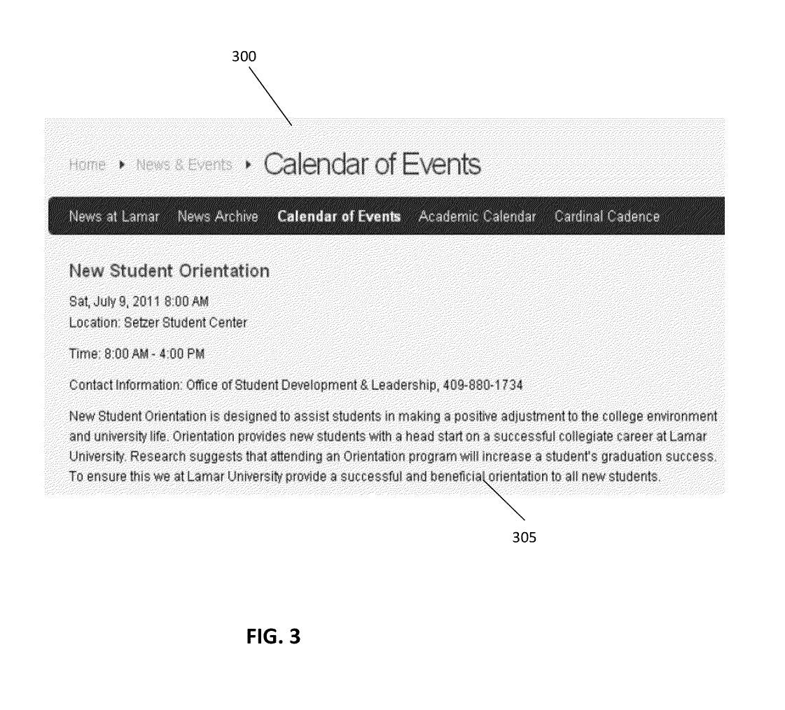

FIG. 3 is diagram of an event details page 300 according to an embodiment. In an implementation, a details page 300 may contain descriptions for one event. As shown, a description 305 of the event is included within an event details page 300. As compared with to a 2-D calendar page or an event list page, an event details page 300 may contain a relatively longer description about a single event.

In a sample study of web event pages, for example, 310 websites with events were randomly selected. Results show that 97.4% of these randomly selected websites (e.g., 302 websites) were found to contain at least one a 2-D calendar event page, an event details page, or an event list page, whereas only 8 of the 310 websites had only free-text event pages. Among these 310 web sites, 48.4% had event calendar pages; 67.8% had event list pages; and 45.2% had event detail pages. It should be noted that in this study, one website may have had more than one type of event page such as, e.g., both 2-D event calendar and event detail pages.

Accordingly, based at least in part on this sample study, it should be appreciated that event pages may be classified into one or more of 2-D calendar event page, an event details page, or an event list page. 2-D calendar event pages, however, may include a 2-D table structure and may therefore be considered to be different from event list and event detail pages. Therefore, two different strategies may be utilized to handle all three types of events pages discussed above—e.g., a 2-D calendar event page, an event details page, or an event list page. In an implementation, a heuristics-based algorithm or process may be utilized to process 2-D calendar event pages, or a semi-supervised learning model may be utilized to process event list or event detail pages.

An event may have one or more attributes. An “attribute,” as used herein may refer to a characteristic or feature that may be descriptive of an event. Examples of event attributes include (a) date/time; (b) location; (c) title; or (d) description.

An event date/time may describe or be indicative of a date or time at which an event scheduled to start or end, such as “July 4th, 2011” or “10/9/2011-10/11/2011,” to name just two among many possible examples.

An event location may be indicative of a place or location at which an event is scheduled or intended to be held.

An event title may comprise a relatively concise introduction of an event. According to one particular implementation, an event title may comprise a short sentence or phrase. An event title may be presented or displayed in front of other descriptions relative to an event on a website. In an implementation, an event title may be written in bold or in a relatively larger font size than that of one or more other attributes, for example.

An event description may be referred to as “event details” on some websites. An event description may provide a detailed description of an event. In one particular implementation, an event page may include or display a relatively long description which may include one or more paragraphs. In one particular implementation, an event description may include or display a relatively short description which contains only a few sentences.

It should be appreciated, however, that in some implementations, a website may omit one or more of the aforementioned examples of event attributes.

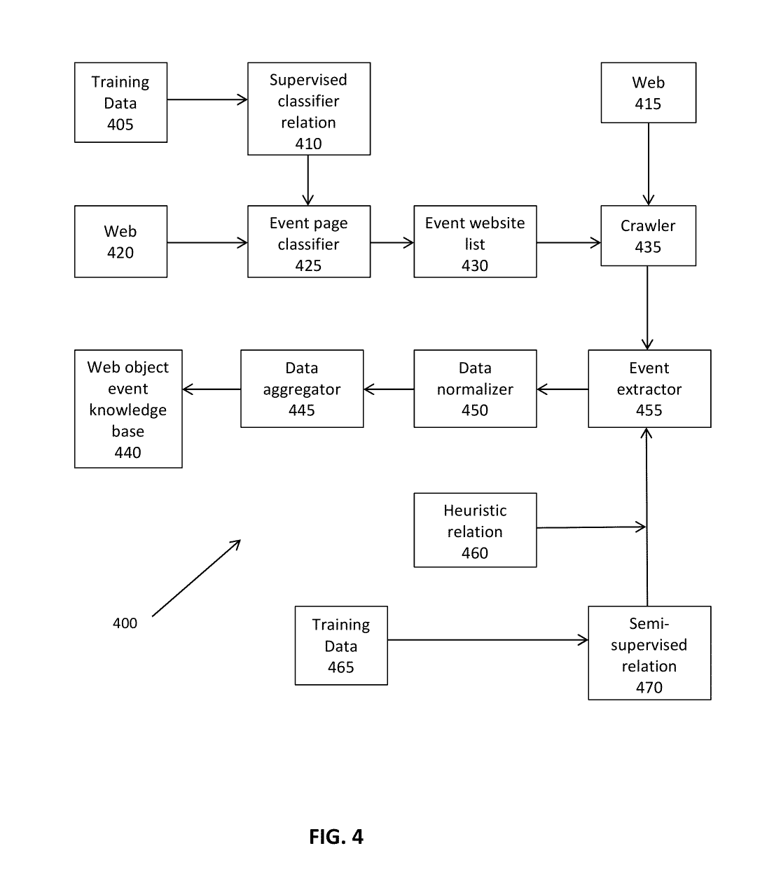

FIG. 4 is a diagram of an automatic event extraction system 400 according to an embodiment. Automatic event extraction system 400 may comprise a supervised binary classification model based at least in part on a Gradient Boosted Decision Tree (GBDT).

Automatic event extraction system 400 may include a number of components, modules, or portions, for example. As shown in FIG. 4, automatic event extraction system 400 may include one or more of training data 405, a supervised classifier relation or algorithm 410, web 415, web data on a grid, 420, an event page classifier 425, an event website list 430, a crawler 435, a web object event knowledge base 440, a data aggregator 445, a data normalizer 450, an event extractor 455, a heuristic relation 460, training data 465, or a semi-supervised relation or algorithm 470.

Crawler 435 may crawl the web 415 or Internet to locate web pages of websites containing descriptions relating to one or more scheduled events. For example, crawler 435 may acquire or collect one or more Uniform Resource Locators (URLs) from event pages from the web 415. Acquired URLs may, for example, be stored as a large list. A web page crawler tool may be applied to crawl web 415, for example at a periodic refresh frequency, or to update web pages according to a URL list.

Training data 405 may be utilized to determine a supervised classifier relation 410. Supervised classifier relation 410 may be determined based at least in part on a machine-learning approach to identify one or more relationships, characteristics, or probabilities of websites or web pages containing event lists or event detail descriptions, for example. Web 420 may comprise descriptions acquired from previously crawled websites. Event page classifier 425 may receive web data and may classify an event page based at least in part on supervised classifier relation 410. A list of one or more event websites 430 may be transmitted or otherwise provided to crawler 435. Crawler 435 may, in turn, transmit or otherwise provide crawled web page or website descriptions or attributes to event extractor 455.

Training data 465 may be utilized to determine or identify a semi-supervised relation 470. As shown, two relations may be applied separately. For example, heuristic relation 460 may be applied for 2-D calendar pages, whereas semi-supervised relation 470 may be applied for list and detail pages.

Event extractor 455 may, for example, extract one or more events from one or more event pages presenting one or more event lists, event details, or 2-D calendars. Event extractor 455 may provide an output to data normalizer 450 to, for example, normalize writing styles utilized on different event pages. For example, data normalizer may be capable of normalizing different attribute writing styles, such as “July 15, 2011” or “07/15/2011.” An output of data normalizer 450 may be provided to data aggregator 445. “Aggregation,” as used herein may refer to a process for accumulating content or attributes descriptive of a common event extracted from different websites. An output of data aggregator 445 may be provided or stored within web object event knowledge base 440.

It should be appreciated that one or more components or items shown in FIG. 4 may be implemented by or stored within one or more servers, for example.

Automatic event extraction system 400 may comprise a binary event page classifier to determine or decide whether a particular web page is an event page or not. As discussed above, automatic event extraction system 400 may be based at least in part on a GBDT. In one particular implementation, several different features may be processed by automatic event extraction system 400. Such features may generally be derived from one or more of: (1) URL/title features; (2) hot phrase features; (3) date, time, or week entity features; or (4) 2-D calendar structure features, as discussed below.

URL/title features may be analyzed for example, because in some cases, words in URLs or titles may imply an event page. For example, a web page with URL “http://www.lpzoo.org/events/calendar” or title “Calendar|Lincoln Park Zoo” is likely to comprise an event page.

Hot phrase features in web page content may be analyzed or considered. For example, there may be some important words or phrases utilized within a body of a web page which may help to identify an event page, such as “upcoming events,” “calendar,” or “schedule,” to name just a few examples.

Date, time, or week entity features may comprise a key attribute for an event. Therefore, it may be viewed as an important feature of an event page, e.g., “Tuesday July 23th, 2011 5:30 pm.”

2-D calendar structure features may be analyzed because some event pages may utilize a 2-D calendar structure to organize or publicize events.

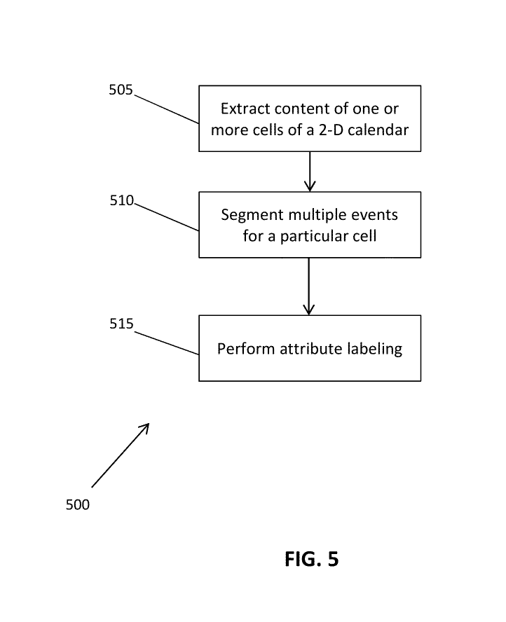

FIG. 5 is a flowchart of a process 500 for 2-D calendar extraction according to an implementation. Embodiments in accordance with claimed subject matter may include all of, less than, or more than blocks 505-515. Also, the order of blocks 505-515 is merely an example order. At operation 505, contents of one or more cells of a 2-D calendar may be extracted. If a particular cell includes descriptions for multiple events, the descriptions may be segmented for the different events at operation 510. Attribute labeling may be performed at operation 515.

A task of day cell extraction as discussed above with respect to operation 505 may be to extract content of one or more cells out of a monthly 2-D calendar. For example, a 2-D calendar may be process to identify a complete segment of a calendar table. For example, if a calendar table includes an HTML format “<table . . . ” or “<div . . . ”, DOM trees or use patterns may be processed to identify or acquire one or more HTML table segments. A speed of DOM parsing may be slow, so a string pattern and a stack structure may be analyzed to acquire any <table> . . . </table> and <div> . . . </div> pairs within HTML code. For example, HTML codes within a pair may be viewed as a segment.

If the string structure of HTML code includes <table> . . . </table>, a structured way to process HTML may include using code <tr> . . . </tr> to separate rows of a 2-D calendar or <td> . . . </td> to separate columns. If, for example, <tr> and <td> code are used, a “<tr>” or “<td>” parser may be utilized to acquire cell elements. However, there may be many structures using other uncommon or irregular patterns. To deal with such cases, a more general parser may be utilized to extract cell content. A process of a general parser is described below.

A complete month calendar may contain at least 28 continuous numbers: 1, 2, 3, . . . , 27, 28, because there are at least 28 days for a month. Accordingly, a segment may be parsed only when it contains 28 continuous numbers in one particular implementation. A 2-D calendar title or first several of a 2-D calendar may contain month descriptions, such as “March 2011,” for example, and may therefore be utilized to identify a beginning of a 2-D calendar. In an implementation, one or more patterns may be used to identify a month. If a table does not list or otherwise indicate the month, a beginning of an event page may be searched to identify the month.

For a cell unit of a 2-D calendar, such as a day, for example, a first part of the cell unit may comprise a date number, such as 1, 2, 3, . . . , 29, 30, or 31. A remainder of a cell unit, for example, after removing tags, may comprise one or more event descriptions. Cell unit numbers may therefore be viewed as a natural boundary between two adjacent cell units or days. If, for example, a cell unit contains multiple events, segmentation may be performed at operation 510 as shown in FIG. 5.

Multiple event segmentation may be performed in one or more ways. In one implementation, an event as shown on a web page or website may a link to a corresponding detail page. Such a link may therefore be utilized for event segmentation.

Multiple event segmentation may be performed based at least in part on a time of day displayed or presented in a cell unit. For example, a website may display or present an event time on a 2-D calendar page such as, for example, “7:00 P.M. city council meeting 8:30 P.M. . . . ” One or more time patterns may be used to fix boundaries for different events.

For relatively difficult situations, multiple event segmentation may utilize a DOM path. For example, one or more distances between the segments may be computed as path distances through a DOM tree. Attributes displayed or presented under a shared event may share the same branch of a website's DOM tree. Accordingly, distances for such attributes may be relatively small. DOM tree distances may be utilized to cluster attributes into different events.

If multi-event segmentation has been performed, attribute labeling may be performed at operation 515 as shown in FIG. 5 to label a segment with its related attribute. It should be appreciated that attribute labeling may be a relatively difficult task. For example, a heuristic process may be utilized to label a time attribute. Other labeling problems may be solved, for example, by using ideas similar to those as in a semi-supervised approach for event list and detail pages, as discussed further below.

Heuristic time labeling may handle the situations including regular writing styles such as 9:00 P.M. or 18:30, for example, or start/end styles, such as “9:00 A.M.-11:00 A.M.,” “3-5 P.M.,” “start time: 9:00 A.M. end time: 11:00 A.M.,” or “from 9:00 A.M. to 11:00 A.M.,” for example.

A process as discussed above with respect to FIG. 5 is directed to event extraction for a 2-D calendar page. However, as previously discussed above, some event pages may include event list or one or more event details, which may be processed in a manner as discussed below.

A challenge to mining event data from list and detail pages is that different sites may use different templates to lay out descriptions of events. A simple solution comprises a supervised method that manually defines rules for each site and extracts event data individually. However, if event data is to be mined or extracted from a relatively large number of webpages of websites, a supervised method may be prohibitively costly, infeasible, and fragile as event pages may frequently be updated or changed.

Two assumptions, for example, may be derived from observation of randomly selected event pages. First, for a website with structured or semi-structured event pages, there may be a website wrapper which is most correlated or similar to web pages and which may be utilized to extract event descriptions. A task may therefore be to generate or rank possible wrappers to identify a best wrapper. Attributes associated with one or more events may be located within a close proximity of each other on a web page. An event page designer may, for example, prefer to put together descriptions for an event in one location. Therefore, a relatively small w, may be utilized to cover an event's attributes.

Based at least in part on assumptions as discussed above, a semi-supervised learning model may be implemented to determine a best wrapper for a particular calendar web page. An event calendar web page, as opposed to a 2-D calendar web page, may comprise an event detail page or an event list page. A semi-supervised method may leverage domain knowledge of events as well as a fact that website template may be repeatedly utilized for multiple event calendar pages within the same website. A semi-supervised method may automatically identify a best template/wrapper for event data extraction without any human intervention in an implementation. A semi-supervised method may comprise two or more steps, such as: (a) given a website, a set of candidate template/wrappers may be generated by analyzing an HTML structure of web pages of the website; or (b) a ranking relation or process may select a best template or wrapper from various candidates upon considering several criteria based on domain knowledge of events and repetitions within the website.

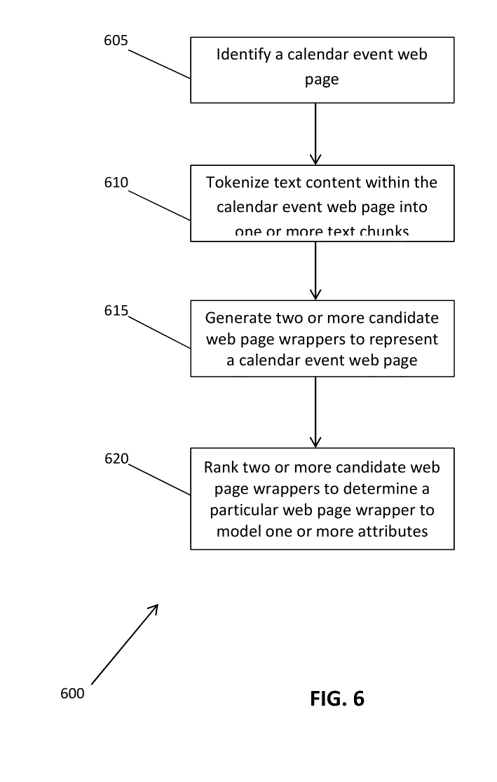

FIG. 6 is a flow diagram of a process 600 to rank two or more candidate web page wrappers according to an embodiment. Embodiments in accordance with claimed subject matter may include all of, less than, or more than blocks 605-620. Also, the order of blocks 605-620 is merely an example order. At operation 605, a calendar event web page may be identified. At operation 610, text content within a calendar event web page may be tokenized into one or more text chunks. At operation 615, two or more candidate web page wrappers may be generated to represent a calendar event web page. At operation 620, the two or more candidate web page wrappers may be ranked to determine a particular web page wrapper to model one or more attributes of a calendar web page.

For an event list or detail page, to generate a candidate wrapper, text content within the event page may be tokenized into text chunks by using tokens such “line breaks” or HTML tags, for example. A text chunk may be represented as a node described by textual content together with its corresponding xpath. Event list extraction may identify which nodes contain event descriptions, that is, to label which node contains “Event Time” or “Event Location,” for example.

An event may contain at least a date or time attribute, which may be viewed as an anchor of the event. Other attributes may be represented as offsets to a date or time attribute. A date or time may occur separately in a page, so a date attribute may be considered as an anchor and a time attribute may be represented as offsets similar to other attributes. Therefore, a wrapper may be described using notation (DateXpath, t, x, y, z). Here, DateXpath may comprise a tag path from a top of a DOM-tree to a node where a date attribute is located such as, for example, “<html> <body> <div> <table> <tr> <td>”. A date attribute's location may be represented as DatePos. A related time, title, location, or description's segments may be on DatePos+t, DatePos+x, DatePos+y, or DatePos+z, respectively. Here, t, x, y or z may be located within a window, −w<=t, x, y, z<=w, where w comprises a window size.

Some attributes may be located within the same segment. For example, t=0 may mean that a date and a time are within the same segment. In such a case, a string pattern may be utilized to separate multiple attributes in a post-processing phase in an implementation.

A candidate template or wrapper may therefore be utilized to extract one or more events from a web page or website. Candidate wrappers may be ranked to determine which one is the best wrapper for extraction of event descriptions from one or more web pages of a particular website. A scoring function may be used to perform ranking. A scoring function may be built that may determine appropriate features to consider for ranking, independent of any given website. One particular benefit is that a scoring function may be learned by using supervision on a relatively small number of randomly chosen sites. One or more features as discussed below may be utilized to determine a score for a wrapper in a ranking process.

For example, a score may be based at least in part on number of event pages extracted from a particular website. For example, a website may tend to utilize the same or a similar template for multiple event pages. Accordingly, a good wrapper may be able to extract event descriptions from more event pages than would a poor or random wrapper.

Similarly, a wrapper score may be at least partially based on a number of items extracted because, for example, a website may tend to utilize a similar template for different items.

A total number of exceptions may be utilized at least partially to determine a wrapper score. As used here, an “exception” may refer to an out-of-bound occurrence. For example, an exception may be present if a DatePos exists in a first segment, but there are no segments on a position of DatePos−8.

A binary attribute may be considered to determine a score for a wrapper. For example, a binary attribute may indicate that a time attribute has a time string pattern such as “5 A.M.” or “7:00 P.M.” In an example, a binary attribute may indicate that a label “location of event” contains locations. Here, a Name Entity Recognizer (NER) Location/Organization may be used to detect location entities.

Characteristics of text utilized within a website may be utilized to determine a score for a wrapper. For example, an average length range of a title or description may be considered. It should be noted that a description may be longer than a title. A title may be written in uppercase. A context feature such as one or more contextual words may indicate an attribute of an event such as, for example, “Date: June 7, 2011” or “Location: city hall.” Similarly, an order of features may be considered because, for example, a title may are sometimes be displayed in front of a description.

A score for a wrapper may be based at least in part on an event list or detail feature. A semi-supervised model may process extraction from one or more of event list or event detail pages. Event list or event detail pages may be distinguished by, for example, using different special features to train or rank wrapper for list or detail pages separately. Since one detail page may contain content descriptive of only one event, but one list page may contain descriptions for multiple events, a different between a number of extracted pages and extracted items may be utilized as a special feature to distinguish between event list or event detail pages.

To train a ranking model, a collection of example event calendar pages and a set of candidate wrappers generated from them may be processed. An individual or supervisor may select which candidate wrapper to apply to one or more example page. A Maximum Entropy model may be utilized from training data to learn a model so that, given an unseen event calendar page with its candidate wrappers, the model is capable of estimating a likelihood of a candidate wrapper to be the right template for event extraction for a given web site. A resulting likelihood function may become a scoring function for ranking wrappers.

A maximum entropy model may be represented by the following relation:

$$p ( t \vert h ) = \frac{1}{Z ( h , t )} exp ( {\sum }_{i = 1}^{n} {λ}_{i} {f}_{i} ( t , h ) ) \qquad [ Relation 1 ]$$

Here t comprises an attribute label, h comprises a set of extracted context segments. p(t|h) may express a probability that segments h are all about attribute t. fᵢ(t, h) may comprise a feature normalized between 0 and 1. A type of f(t, h)s may comprise one or more features as discussed previously above. The λᵢ may comprise a weight associated with feature fᵢ and may be computed using a Generalized Iterative Scaling (GIS) procedure on a training set. Here, a GIS procedure may be utilized within a Maximum Entropy model. Z(h, t) may comprise a normalization factor (partition function) so that =1.

Performance of binary event page classification, 2-D calendar event page extraction and semi-supervised list or detail page extraction has been verified with experimental results. In an experiment, 1,055 event pages were collected from the Internet for training purposes, and 1,014 event pages were randomly collected and manually annotated or testing purposes. Experimental results showed that a classifier was found to have achieved results with 88.36% precision.

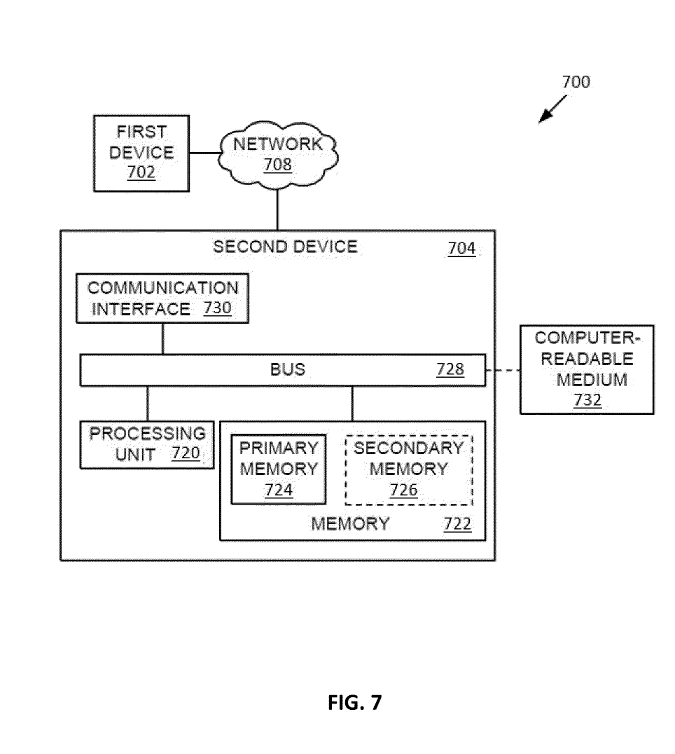

FIG. 7 is a schematic diagram illustrating a computing environment system 700 that may include one or more devices to automatically extract hyper-local events from one or more web pages. System 700 may include, for example, a first device 702 and a second device 704, which may be operatively coupled together through a network 708.

First device 702 and second device 704, as shown in FIG. 7, may be representative of any device, appliance or machine that may be configurable to exchange signals over network 708. First device 702 may be adapted to receive a user input signal from a program developer, for example. First device 702 may comprise a server capable of transmitting one or more quick links to second device 704. By way of example but not limitation, first device 702 or second device 704 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or storage service provider/system, a network service provider/system, an Internet or intranet service provider/system, a portal or search engine service provider/system, a wireless communication service provider/system; or any combination thereof.

Similarly, network 708, as shown in FIG. 7, is representative of one or more communication links, processes, or resources to support exchange of signals between first device 702 and second device 704. By way of example but not limitation, network 708 may include wireless or wired communication links, telephone or telecommunications systems, buses or channels, optical fibers, terrestrial or satellite resources, local area networks, wide area networks, intranets, the Internet, routers or switches, and the like, or any combination thereof.

It is recognized that all or part of the various devices and networks shown in system 700, and the processes and methods as further described herein, may be implemented using or otherwise include hardware, firmware, software, or any combination thereof (other than software per se).

Thus, by way of example but not limitation, second device 704 may include at least one processing unit 720 that is operatively coupled to a memory 722 through a bus 728.

Processing unit 720 is representative of one or more circuits to perform at least a portion of a computing procedure or process. By way of example but not limitation, processing unit 720 may include one or more processors, controllers, microprocessors, microcontrollers, application specific integrated circuits, digital signal processors, programmable logic devices, field programmable gate arrays, and the like, or any combination thereof.

Memory 722 is representative of any storage mechanism. Memory 722 may include, for example, a primary memory 724 or a secondary memory 726. Primary memory 724 may include, for example, a random access memory, read only memory, etc. While illustrated in this example as being separate from processing unit 720, it should be understood that all or part of primary memory 724 may be provided within or otherwise co-located/coupled with processing unit 720.

Secondary memory 726 may include, for example, the same or similar type of memory as primary memory or one or more storage devices or systems, such as, for example, a disk drive, an optical disc drive, a tape drive, a solid state memory drive, etc. In certain implementations, secondary memory 726 may be operatively receptive of, or otherwise able to couple to, a computer-readable medium 732. Computer-readable medium 732 may include, for example, any medium that can carry or make accessible data signals, code or instructions for one or more of the devices in system 700.

Second device 704 may include, for example, a communication interface 730 that provides for or otherwise supports operative coupling of second device 704 to at least network 708. By way of example but not limitation, communication interface 730 may include a network interface device or card, a modem, a router, a switch, a transceiver, or the like.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
determining, via an automated process, whether a web page comprises an event page indicating a scheduled event;
extracting one or more descriptors of the scheduled event from the web page at least partially in response to determining that the web page comprises the event page.

2. The method of claim 1, further comprising classifying the web page as one or more of a 2-dimensional (2-D) calendar page, an event list page, or an event detail page at least partially in response to determining that the web page comprises the event page.

3. The method of claim 2, wherein at least partially in response to determining that the web page comprises a 2-D calendar page, processing Hypertext Markup Language (HTML) code of the web page to identify one or more HTML tags indicative of one or more cells of the 2-D calendar page.

4. The method of claim 2, wherein at least partially in response to determining that the web page comprises a 2-D calendar page, identifying one or more cells and extracting the descriptors of the event from the one or more cells.

5. The method of claim 2, wherein at least partially in response to determining that the web page comprises a 2-D calendar page, performing a heuristic process to identify the one or more descriptors of the scheduled event within the one or more cells.

6. The method of claim 2, further comprising performing segmentation on a particular cell of one of more cells of the 2-D calendar page at least partially in response to determining that the web page comprises the 2-D calendar page and further in response to identifying content descriptive of multiple events within the particular cell.

7. The method of claim 2, wherein at least partially in response to determining the web page comprises an event list page, implementing a semi-supervised process to extract the one or more descriptors of the event from one or more event lists of the web page.

8. The method of claim 7, wherein the implementing a semi-supervised process comprises comparing the web page to one or more web page wrappers to identify a related wrapper.

9. The method of claim 8, wherein the one or more descriptors of the scheduled event are extracted from the web page based at least in part on a comparison of the related wrapper to one or more features of the web page.

10. An apparatus, comprising:
a receiver to receive one or more signals;
a processor to:
determine, via an automated process performed at least partially in response to receiving the one or more signals, whether a web page comprises an event page comprising descriptors of a scheduled event; and
extract the descriptors of the scheduled event from the web page at least partially in response to determining that the web page comprises the event page.

11. The apparatus of claim 10, wherein the processor is further capable of classifying the web page as one or more of a 2-dimensional (2-D) calendar page, an event list page, or an event detail page at least partially in response to determining that the web page comprises the event page.

12. The apparatus of claim 10, wherein the processor is further capable of processing Hypertext Markup Language (HTML) code of the web page to identify one or more HTML tags indicative of one or more cells of the 2-D calendar page at least partially in response to determining that the web page comprises the 2-D calendar page.

13. The apparatus of claim 11, wherein the processor is further capable of identifying one or more cells and extracting the descriptors of the event from the one or more cells at least partially in response to determining that the web page comprises the 2-D calendar page.

14. The apparatus of claim 13, wherein the processor is further capable performing a heuristic process to identify the descriptors of the scheduled event within the one or more cells.

15. The apparatus of claim 11, wherein the processor is further capable of implementing a semi-supervised process to extract the descriptors of the event from one or more event lists of the web page at least partially in response to determining that the web page comprises an event list page.

16. The apparatus of claim 15, wherein the processor is further capable of implementing a semi-supervised process comprising comparing the web page to one or more web page wrappers to identify a relevant wrapper.

17. An article, comprising:
a storage medium comprising machine-readable instructions executable by a special purpose apparatus to:
identify a calendar event web page;
tokenize text content of the calendar event web page into one or more text chunks;
generate two or more candidate web page wrappers to represent the calendar event web page; and
rank the two or more candidate web page wrappers to determine a particular web page wrapper to model one or more attributes of the calendar web page.

18. The article of claim 17, wherein the ranking comprising determining ranking scores for the two or more candidate web page wrappers.

19. The article of claim 17, wherein the one or more text chunks are represented as a node and an Xpath.

20. The article of claim 17, wherein the ranking is performed via a machine-learning based ranking process.
